(19) United States
(12) Patent Application Publication
(10) Pub. No.: US 2005/0288418 A1
(43) Pub. Date: Dec. 29, 2005

(54) Article having a multilayer film including at least one layer containing metallic components and method of making the same

(75) Inventors: Christian G. Mayville, St. Clair Shores, MI (US); Christopher J. Wawsczyk, Mount Clemens, MI (US)

Correspondence Address: YOUNG & BASILE, P.C., 3001 WEST BIG BEAVER ROAD, SUITE 624, TROY, MI, 48084, US

(73) Assignee: Mayco Plastics, Inc., Sterling Heights, MI (US)

(21) Appl. No.: 11/105,901

(22) Filed: Apr. 14, 2005

Related U.S. Application Data
(60) Provisional application No. 60/562,173, filed on Apr. 14, 2004.

(51) Int. Cl. C08K 3/08

(52) U.S. Cl. 524/439

(57) ABSTRACT

A layered film having at least one layer containing metallic particulate in an extrudable thermoplastic material such as an ionomer, ionomeric precursor or the like, and a molded article containing the same. The layered film can be produced by an extrusion process.

The present invention claims priority to U.S. Provisional Application Ser. No. 60/562,173, filed Apr. 14, 2005.

### BACKGROUND

The present invention pertains to multilayer polymeric films in which at least one layer contains metallic constituents dispersed therein. More particularly, the present invention pertains to multilayer film constituents having at least one ionomeric layer having metallic particulate material dispersed therein as well as methods for making the same. Finally, the present invention also pertains to articles having polymeric substrates having a multilayer film disposed thereon having metallic constituents dispersed in at least one layer.

The aesthetic value and desirability of various items can be enhanced if the items can be formulated in a variety of colors or hues. For instance, various native polymeric materials exist in shades of gray, or natural tans. To render these more pleasing, it has been contemplated that the materials can be pigmented with various shades. However, the finish of the polymeric articles can lack the sheen, luster, or beauty desired.

It has been proposed that the polymeric substrate be painted or overlaid by a suitable pigmented lacquer material applied in a spray, dip, or brush application process. However, such processes are labor intensive, may not impart the desired surface finish, and can present surface adhesive difficulties. Accordingly, it has been proposed that a polymeric film be integrated into overlying relationship with the desired surface or surfaces of a polymeric substrate. The polymeric film can be composed of one or more layers with at least one layer colored to the desired shade or hue. Such films can be integrated with the substrate article by various methods. One such example of a suitable method includes injection molding processes.

Heretofore, such colored polymeric films have been successfully manufactured by casting processes. However, such processes are labor intensive and present difficulties when multilayer film constructs are desired. Extrusion methods have been proposed in the past. However, extrusion methods producing multilayer films suitable for use as a colored or pigmented outer layer have been problematic. Extruded films using materials such as various polymeric materials such as ionomers in one or more of the multiple layers of the film construct have been difficult to produce successfully. Integration of metallic components into the appropriate layer and incorporation into the suitable substrate article has resulted in areas of undesirable discoloration and/or discontinuity in characteristics such as color or texture in the surface or near surface regions of the finished product.

Thus, it would be desirable to provide a multilayer film having at least one pigmented metallic layer that can be integrated onto the surface of a desired substrate article to produce a substantially uniform, aesthetically pleasing outer surface. It is also desirable to provide an article having an outer surface that has an aesthetically pleasing, uniform color characteristic that incorporates metallic components. It would be desirable to provide a method for producing a suitable polymeric film. Finally, it would be desirable to provide a metallic concentrate that can be integrated into a polymeric matrix to provide a suitable polymeric film.

### SUMMARY

Disclosed herein is an article having a substrate and an outer surface composed of a pigmented polymeric film. The pigmented film has at least one layer containing metallic particulate material dispersed therein. The film is composed of a thermoplastic material and is characterized by essentially uniform polymerization characteristics throughout the layer. The metallic particulate material is composed of at least one metal or metal compound having a mineral oil encapsulate below a predetermined threshold associated therewith. The pigmented film can include multiple layers such as a an exteriorly oriented clear polymeric layer, a pigmented ionomeric layer underlying the clear coat, a suitable backing layer composed of an appropriate polymer such as a polyalkylene polymer associated with the pigmented ionomeric layer, and a suitable tie layer interposed between the backing layer and the pigmented ionomeric layer.

The metallic particulate material can be present in a layer that also contains suitable particulate pigments that provide color to the polymer matrix. Alternately, the metallic particulate material can be integrated into a separate layer as desired or required.

The metallic particulate material can be integrated into the polymeric matrix at any suitable point, typically during film formation. The metallic particulate material to be integrated can be present as particles dispersed in a suitable polymeric carrier material that can be readily integrated into an ionomeric process stream during the film formation process where it can be co-extruded with other suitable materials to form a multilayer construct.

The resulting film can be introduced into a suitable mold cavity and subjected to suitable article formation processes such as injection molding.

### DESCRIPTION OF THE DRAWING

The objects, features, and advantages of the disclosure herein will become more readily apparent from the following description, reference is being made to the following drawings in which:

FIG. 1 is a sectional view through a polymeric film material as disclosed herein;

FIG. 2 is a cross-sectional view of a film coating depicting inclusions and agglomerations as found in prior art methods; and

FIG. 3 is a process flow diagram outlining a general process of providing an article as disclosed herein; and

FIG. 4 is a process flow diagram outlining detailed process as disclosed herein.

### DESCRIPTION OF THE EMBODIMENT

Disclosed herein is a polymeric film having metallic particulate material dispersed in an essentially in a polymeric matrix exhibiting essentially uniform polymerization characteristics throughout. The polymeric matrix includes an ionomeric compound or compounds integrated therein. The film may have multiple additional layers including, but not limited to, unpigmented or clear layers, backing or reinforcement layers, tie or adhesion layers, and the like. Additionally, the polymeric film may optionally include multiple layers each containing different pigments to achieve appropriate color, hue, or visual characteristics. The film disclosed herein is one suitable for incorporation into or onto the surface region of a suitable polymeric article or work piece.

The metallic particulate may be any suitable solid material composed in whole or in part of metal or metallized material that can be incorporated into the polymeric matrix of the given polymeric layer. The metallic particulate can be configured as any suitable shape or shapes including but not limited to flakes, threads, spheres, granules, and the like in order to provide suitable optical qualities. Suitable optical qualities can include but are not limited to reflectance, shimmer, sheen, and the like. It is contemplated that the metallic particulate will have a size sufficient to provide visible characteristics. Typically the metallic particulate has a size greater than 10 microns. The metallic particulate size will generally have a size between the limits of visible perception and an upper range bounded by layer thickness. It is contemplated that the metallic particulate will have a size maximum below 0.002 to 0.050 inch.

It is also contemplated that the film may incorporate particulate pigment to impart color characteristics to the film layer and/or film construct. The particulate pigment may be any suitable solid material that can be incorporated into the polymeric matrix of the desired polymeric layer. The particulate pigment can have any suitable shape or shapes including but not limited to flakes, spheres, granules or the like in order to provide suitable color and optical qualities. The particulate pigment will have a particle size sufficient to permit extrusion and to provide the desired optical qualities in the resulting film.

Also disclosed herein is a method for preparing a polymeric film containing an ionomeric constituent and metallic particulate material dispersed therein. The metallic material is initially incorporated in a suitable polymeric carrier medium that can include at least one encapsulating medium and an ionomeric compound. The resulting admixture can be pelletized into an appropriate solid pellet construct that can be incorporated into a suitable polymeric feed stream and produced into a film layer in a suitable extrusion device and process.

The multilayer plastic film 12, disclosed herein, can be made using a suitable polymeric coextrusion process. The multilayer polymeric film 12 can be composed of at least one layer containing metallic particulate. Typically, the new multilayer polymeric film can be composed of two or more coextruded layers typically including an outer clear layer 14 in overlying relationship to a pigmented and/or metallic polymeric layer 16. Layers 14 and 16 are positioned in overlying relationship to a backing layer 18 and can be suitably adhered to the backing layer 18 by a suitable tie layer 20. The various layers, 14, 16, 18, and 20 form a unitary coextruded film such as thermoplastic film 12.

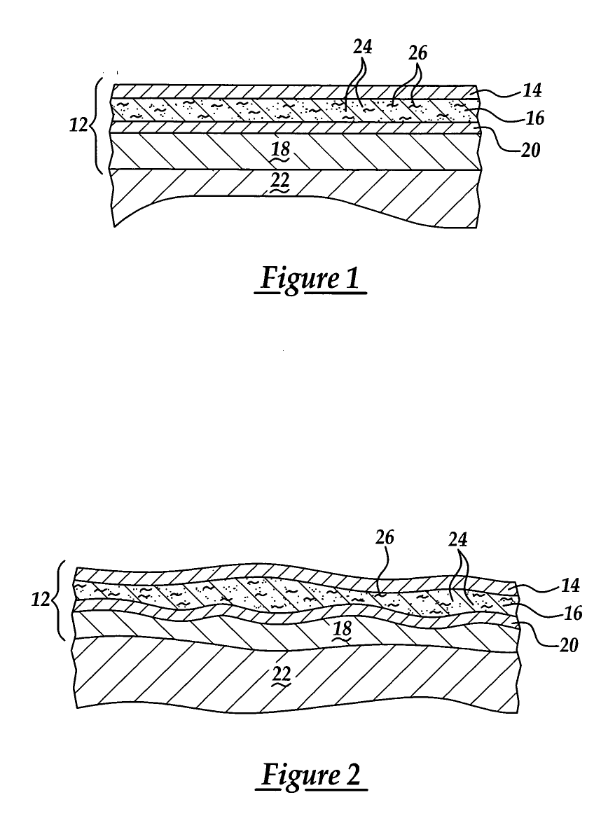

As depicted in FIG. 1, the film 12 is adhered in overlying relationship to a suitable substrate 22. Substrate 22 is typically placed into essentially permanent contact with the film 12 through a suitable process such as injection molding and can be composed of any appropriate compatible material. It is contemplated that the substrate 22 can be associated with any suitable end use article. One nonlimiting example of such articles includes components for automotive applications. Such automotive components include but are not limited to bumpers, automotive fascia, body panels, and the like, both for interior and exterior applications.

As disclosed herein, the thermoplastic film 12 includes appropriate pigmentation and color augmentation present as pigment particles 24 dispersed throughout at least one layer of the film 12. As depicted herein, particles 24 are dispersed through layer 16. The film 12 also includes suitable metallic particles 26 in dispersed relationship therein. The metallic material can have any suitable configuration or geometric shape as desired or required to enhance or pigment the resulting film 12. The metallic material as depicted is in the form of flakes 26. However, the metallic material can be in the form of spheres, nodules, or combinations of geometric configurations as configured to provide the desired visual effect. It is also contemplated that various other visual enhancement additives, nonexamples of which include opalescence additives and the like.

It is contemplated that the outermost or clear or optically transmissive layer 14 may be composed of any suitable clear polymeric material. Examples of suitable thermoplastic materials include, but need not be limited to, ionomers derived from sodium, lithium, or zinc, and ethylene/unsaturated carboxylic acid or anhydride copolymers. Suitable ionomer resins include, but are not limited to, those available from Dupont under the trade name SURLYN. These resins are identified as being derived from sodium, lithium, or zinc, and copolymers of ethylene and methacrylic acid. Included in this group are sodium-containing ionomers available under the SURLYN name and having the following designations: 1601, 1605, 1707, 1802, 1901, and the like. Also included are zinc-containing ionomers available under the SURLYN name having the following designations: 1650, 1652, 1702, 1705-1, 1855, and 1857. Lithium-containing ionomers available under the SURLYN name include the following designations: AD8546, 7930, and 7940.

It is contemplated that suitable acid copolymers of various alkylenes and carboxylic acid and/or anhydrides can be neutralized in whole or in part with metal ions such as sodium, lithium, and/or zinc. The degree of neutralization ca vary depending upon the particlate compound characteristics. Monomeric material is available from various sources. Nonlimiting examples of such sources include A. Schulman under the trade name FORMION and Exxon Mobile under the trade name IOTEK.

It is contemplated that the polymeric material can also be composed, at least in part, of ionomeric precursors. “Ionomeric precursors” as that term is employed herein, is taken to mean homopolymers, monomeric compounds, and various constituents used to prepare ionomeric materials.

As defined herein, the term “clear” as used with the clear layer 14 is defined as a material that can be seen through. The term “optically transmissive” as used herein is taken to mean to desired wavelengths of electromagnetic radiation such as in visible light. Generally transmissivities greater than 50% of visible light are contemplated with high transmissivities of greater than 90% being useful. The polymeric material of choice employed in the clear layer 14 can be one that imparts suitable scratch and abrasion resistance as desired or required. As such, it is contemplated that the clear layer can include suitable abrasion resistance enhancing additives as would be known to the skilled artisan. It is also contemplated that the clear layer can include additives which impart ultraviolet resistance and resistance to other undesirable environmental factors. Once again, such additives are typically known to the skilled artisan.

Where the clear layer contains additive materials as discussed previously, it is contemplated that concentrations of light stabilizers such as ultraviolet (UV light absorbers and/or other light stabilizers can be employed. These additives are included to provide characteristics such as enhanced outdoor weatherability properties. The concentrations of light stabilizers in the clear layer can be in any suitable range. Exemplary ranges include about 1,000 to about 20,000 ppm based on the weight of the clear layer 14. Exemplary concentrations can, more specifically, include concentrations in the range of about 2,000 to about 20,000 ppm based on weight with more specific ranges varying from about 5,000 to about 20,000 ppm, or about 8,000 to about 18,000 ppm. Useful light stabilizers include the hindered amine light stabilizers. The hindered amine light stabilizers may, for example, be derivatives of 2,2,6,6-tetraalkyl piperidines or substituted piperizinediones. A number of hindered amine light stabilizers useful in the invention are available commercially such as from Ciba-Geigy Corporation under the general trade designations “Tinuvin” and “Chemissorb”, and from Cytec under the general designation “Cyasorb-UV.” Examples include Tinuvin 783 which is identified as a mixture of poly [[60[(1,1,3,3,-tetramethylbutyl)amino]-1,3,5-triazine-2,4-diyl][[2,2,6,6-tetramethyl-4-piperidyl)imino]hexamethylene [(2,2,6,6-tetramethyl-4-piperidyl)imino]] and dimethyl succinate polymer with 4-hydroxy-2,2,6,6-tetramethyl-1-piperidineethanol; Tinuvin 770 which is identified as bis-(2,2,6,6-tetramethyl-4-piperidinyl)-sebacate; Tinuvin 765 which is identified as bis-(1,2,2,6,6-pentamethyl-4-piperidinyl)-sebacate; Tinuvin 622 which is a polyester of succinic acid and N-beta-hydroxy ethyl-2,2,6,6-tetramethyl-4-hydroxy-piperidine; and Chemissorb 944 which is poly[6-(1,1,3,3-tetramethylbutyl)amino]-s-triazine-2,4-diy[[2,2,6,6-tetramethyl-4-piperidyl)imino]hexamethylene (2,2,6,6-tetramethyl-4-piperidyl)imino]. A useful stabilizer is available under the trade name Ampacet 10561 which is a product of Ampacet identified as a UV stabilizer concentrate containing 20% by weight of a UV stabilizer and 80% by weight of a low density polyethylene carrier resin; the UV stabilizer in this product is Chemissorb 944. Useful light stabilizers are also provided in Ampacet 150380 and Ampacet 190303, both of which are pigment concentrates discussed above. Ampacet 150380 has a UV stabilizer concentration of 7.5% by weight. Ampacet 190303 has a UV stabilizer concentration of 4% by weight. The UV stabilizer in each of these products is Chemissorb 944. Ampacet LR-89933 is a gray concentrate having a UV stabilizer concentration of 4.5% by weight, the UV stabilizer being Tinuvin 783.

Various materials and compounds can be added to enhance scuff and abrasion resistance. Non-limiting examples of these materials include primary amides such as stearamide, behenamide, oleamide, erucamide, and the like; secondary amides such as stearyl erucamide, erucyl erucamide, oleyl palimitamide, stearyl stearamide, erucyl stearamide, and the like; ethylene bisamides such as N,N-ethylenebisstearamide, N,N-ethylenebisolamide and the like; and combinations of any two or more of the foregoing amides. Examples of suitable additive packages include those utilized as antislip additives. Non-limiting examples of such materials include additive packages available from Dow Chemical such as Elvax CE9619-1. This resin concentrate contains 20% by weight silica, 7% by weight of an amide slip additive, and 73% by weight of Elvax 3170 (a product of DuPont identified as an ethylene/vinyl acetate copolymer having a vinyl acetate content of 18% by weight). The additive can be used at a concentration in the range of up to about 1% by weight, and in one embodiment about 0.01% to about 0.5% by weight. The slip additive can be used at a concentration in the range of up to about 5% by weight, and in one embodiment between 0.01% and 0.5% by weight. In various embodiments, slip additive can be incorporated in amounts greater than 1 percent utilizing fatty acid based materials. The total amount of material employed will be an amount that is less than that which will adversely effect gloss characteristics for the clear layer. This will generally be amounts less that about 2000 ppm additive by weight of the clear layer, with levels below about 1500 being preferred.

The multilayer polymeric film 12 also includes at least one polymeric layer 16. The polymeric layer 16 is typically positioned such that the outer clear layer 14 is in overlying relationship with the polymeric layer 16. As depicted in FIG. 1, the clear layer 14 can be in direct overlying relationship and contact with at least one polymeric layer 16. It is also contemplated that the multilayer polymeric film 12 can include multiple polymeric layers 16 as desired or required. The polymeric layer or layers 16 can include various pigmenting and opacifying agents that will provide the color, hue, and desired level of opacity for the multilayer film 12. The polymeric layer 16 is composed of a suitable melt processible and extrudable thermoplastic polymer or polymers.

The thermoplastic material employed in the polymeric layer 16 can be ionomers and ionomeric precursors such as those previously discussed with regard to the clear layer. Examples of suitable ionomers include alkylene-unsaturated carboxylic acid and anhydride copolymers neutralized with at least one of sodium, lithium, or zinc, such as neutralized ethylene-methacrylic acid copolymers.

It is contemplated that the polymeric material used in polymeric layer(s) 16 may also include minor amounts of various other polymeric compounds or materials. It is also contemplated that the polymeric material employed in the pigmented polymeric layers 16 can also include various additives such as UV stabilizers and the like, as desired or required. Nonlimiting examples of suitable additives are those listed previously in connection with clear layer 14.

The polymeric layer can include various materials suitable for providing the appropriate color or hue characteristics as desired or required. Nonlimiting examples of suitable pigments include various metallic pigments, heavy metal-based pigments, heavy-metal free pigments, or various organic pigments. As used herein, a heavy metal pigment is defined as one including lead, cadmium, chromium, or antimony, or complexes derived therefrom. The pigments that can be successfully used include titanium dioxide, both rutile and anatase crystal structure. The titanium dioxide may be coated or uncoated. The pigment can be dispersed in the polymeric matrix in any suitable fashion which will provide the desired color or hue characteristics.

Nonlimiting examples of suitable materials include materials available as pigment concentrates or additive packages that can be added to the ionomeric matrix during processing. The pigment additive packages are typically pigments present in polymeric or resin carriers. Suitable resin carriers include various thermoplastic polymers having a melting point of in the range of about 100° C. to about 175° C. Examples of such materials include polyethylene, polypropylene, polybutylene, ionomeric materials and the like. The pigment material can be present in the concentrate such that the blend is between 5 percent and 95 percent by weight polymeric matrix, and 95 percent and 5 percent pigment material, with ranges between 30 and 70 percent being contemplated. Examples of suitable pigments include those generally found in commercially-available pigment packages. An example of a commercially available pigment concentrate that can be suitably used is one available from A. Shulman, Inc. under the trade name Polybatch White P8555 SD. This material is identified as a white color concentrate having a coated rutile titanium dioxide concentration of 50 percent by weight in a polypropylene homopolymer carrier resin. Additional nonlimiting examples fo pigment materials include Ampacet 150380. This material is a product of Ampacet Corporation and is identified as a red pigment concentrate. Ampacet 190303 is also a produce to Ampacet Corporation, and identified as a black pigment concentrate. Ampacet LR-87132 Orange PE MB is also a product of Ampacet Corporation, and is identified as a lead molybdate/lead chromate pigment concentrate. Examples of heavy-metal free pigment concentrates that can be used include Ampacet LR-86813 Yellow UV PE MB, Ampacet LR-86810 Red PE MB, Ampacet LR-86816 Orange PE MB, and Ampacet LR-86789 red UV PE MB. It is contemplated that the concentrations of pigment in the resulting pigmented layer 16 can be up to about 25 percent by weight.

It is contemplated that various pigments of a variety of colors can be advantageously employed in the concentrate matrix. The pigment employed can be one or more particulate materials capable of dispersing in the polymeric matrix which, upon extrusion, yields desired color, hue, and opacity characteristics. The particulate pigment of choice is one capable of maintaining particulate characteristics in both the carrier and resulting polymeric matrix and exhibiting sufficient thermal stability to permit extrusion processing.

It is contemplated that the pigment or pigments employed will be ones that can provide appropriate light reflectivity characteristics as well as color consistency and repeatability from part to part and in each individual part depending on the angle of incidence from which the part is viewed. The pigment(s) of choice will be those that exhibit compatibility with ionomeric material in the melt extrusion process.

Without being bound to any theory, it is believed that at least a portion of both the particulate pigment and the metallic particulate is integrated or associated into the ionic matrix during melt processing and extrusion thereby contributing to dispersion within the matrix and establishing a sufficiently random orientation to contribute to the visual color repeatability of the material.

In order to provide enhanced visual effects, either the polymeric layer 16 or an additional layer (not shown) can include metallic particulate dispersed therein. The metallic particulate material can include at least one of aluminum, silver, tin, graphite, or the like. The metallic particulate material can be present as particles of the specific metal as well as alloys of the aforementioned metals with each other or other compounds. It is also contemplated that the metallic particulate material can be a metallic substrate; i.e. a material with metal deposited thereon. The metallic particulate can have any suitable form desirable to achieve the appropriate sparkle or other visual effect. Thus, the metallic particulate material can be present in the form of flakes, geometric shapes, such as spheres, granules, or the like. It is also contemplated that the metallic material can be present in a plurality of shapes and sizes as desired or required to provide the appropriate or desired visual effect.

The metallic particulate material 24 will be of a size that disperses readily in the polymeric matrix while providing the desired light diffraction, reflectivity, and the like. The metallic particulate material 24, when dispersed in the polymeric matrix, will be oriented with a sufficient degree of randomness to ensure that the perception and reflectivity are perceived as essentially uniform regardless of the angle of view.

Without being bound to any theory, it is believed that extrusion of the metallic particulate material in the ionomeric matrix achieves dispersion of the metallic particulate throughout the matrix in a random or essentially random manner that minimizes adverse polymeric interactions.

The metallic particulate material 26 can be integrated into the pigmented polymeric layer 16 in the form of a concentrate containing the metallic particulate. The concentrate can contain, for example, 5 percent to about 80 percent by weight metallic particulate material, and about 95 percent to about 20 percent by weight polymeric carrier material. It is contemplated that the concentrate can be a matrix containing both pigment material and metallic particulate. Alternately, it is contemplated that the metallic particulate material can be contained in a suitable concentrate independent of one or more of the pigment additives.

The concentrate containing metallic particulate material also contains a suitable encapsulating agent. The encapsulating agent is one capable of compatibilizing the metallic particulate material in the polymeric matrix of the concentrate and, ultimately, in the polymeric material employed in the polymeric layer 16.

Without being bound to any theory, it is believed that the encapsulating agent functions as a compatibilizer to provide suitable integration of the metallic material into the polymeric matrix of the concentrate. The encapsulating agent may further provide compatibilization characteristics when integrated into the polymeric matrix of the polymeric layer 16.

The encapsulating agent is present in an amount sufficient to facilitate integration into the polymeric resin of the concentrate and, ultimately, the polymeric matrix of the pigmented resin layer. The concentration of encapsulating agent is present at a level below the volatilization threshold. As defined herein, the term “volatilization threshold” is defined as the concentration level of encapsulating agent above which the encapsulating agent material experiences significant volatilization phenomena upon subsequent extrusion processing utilized to form the film material disclosed herein. As employed herein, “encapsulation agent volatilization phenomena” is any process whereby at least a portion of the encapsulating agent converts to its gaseous state and/or reacts to form at least one gaseous material. The gaseous material may be the result of a direct phase change, a reaction product, or a byproduct that migrates through the polymeric matrix or a portion of the polymeric matrix while the polymeric material is in its molten or semi molten state. The gaseous material liberated or generated may also migrate through additional associated layers during co-extrusion processing.

Occurrence of the volatilization phenomena can be characterized by surface imperfections either at the layer/layer boundary and/or at the outer surface. Outer surface imperfections are typically characterized as small craters or irregularities centered at the point of volatile migration. Layer/layer imperfections are typically characterized as irregularities at the layer/layer boundary. Either irregularity or imperfection can adversely affect the aesthetic visual appearance of the material. The volatilization threshold limits can vary depending upon the encapsulating agent employed.

As disclosed herein, the encapsulating agent is a mineral oil having a viscosity and performance characteristics compatible with the metallic material and the associated polymeric matrix. Without being bound to any theory, it is believed that the encapsulating agent, present below the volatilization threshold limit, associates with the metallic particulate material in a manner which facilitates uptake and dispersion of the metallic particulate material in the polymeric matrix, first in the concentrate, then in the polymeric layer 16. It is also theorized that the encapsulating agent minimizes attractive characteristics between metallic particles. Non-limiting examples of the attractive forces include various electrostatic attractive forces as well as physical agglomeration and the like. Presence of the encapsulating agent at levels below volatilization threshold limits effectively permits the various metallic particulate elements to orient independently of one another relative to the polymeric matrix, thereby accomplishing a more homogeneous dispersion of the metallic particles in the polymeric matrix.

The encapsulating agent of choice can be any suitable organic material possessing appropriate heat stability at the film processing parameters disclosed herein. The material of choice will be one that exhibits minimal thermal degradation at polymeric processing temperatures up to 600° F. in one embodiment and up to 500° F. in another embodiment. The material of choice is a hydrocarbon or mixture of hydrocarbons derived from petroleum distillates generally referred to as mineral oil. It is believed that the material employed is heat stable at film formation processing temperatures and has a volatilization at or above the processing temperatures employed in film formation. As used herein, “heat stability” is taken to be a minimal formation of cross linked inclusions in polymeric layer 16 and minimization of localized discoloration believed to be due to heat-induced degradation of polymeric compatibilizers.

While it is contemplated that particulate pigment and metallic can be integrated into the polymeric matrix of a given layer of film such as layer 16, it is also within the purview of this disclosure that particulate pigment and metallic particulate are present in discrete layers as desired or required.

The polymeric film construct 12 further includes a suitable backing layer 18. The backing layer 18 can be composed of at least one thermoplastic polymer such as those discussed below. The core layer may be composed of a single thermoplastic polymer or a blend of thermoplastic polymers as desired or required. The backing layer 18 may also be composed of blends of various thermoplastic polymers and suitable adhesive materials. Additionally, the backing material in the backing layer may include other processing components and stabilizing components as desired or required.

As disclosed herein, the backing layer 18 can be composed of various melt-processible polymeric materials. Nonlimiting examples of suitable melt processible polymeric materials include various melt processible polyolefins. Other thermoplastic polymers having similar processing characteristics can be effectively employed as desired or required.

Polyolefins that are useful in the backing layer include, but are not limited to, polyethylene, polypropylene, polybutylene, as well as copolymers of ethylene, propylene or butylenes with various alphaolefins. The alphaolefins include those containing three to eighteen carbon atoms. Such materials include propylene, ethylene, butylenes, butene, hexane, 4-methyl pentene, octane, and the like. It is also contemplated that the polyolefin backing layer may be made of a blend of polyolefins such as polyethylene and various materials such as ethylene propylene copolymers. Medium density polyethylenes and linear medium density polyethylenes can be useful in the construction disclosed herein.

The material of choice will be one that can impart flexible strengthening characteristics to the thermoplastic film 12. Additionally, the material of choice in the backing layer 18 will be one that will exhibit appropriate adhesion characteristics with the material or materials employed in the substrate 22.

Where desired or required, the backing layer 18 can incorporate suitable compounds or additives to promote adhesion with the ionomeric layer or any appropriate layers interposed there between. Such adhesion-promoting additives are present in minor amounts of the composition and can include various ionomeric compounds as previously enumerated as well as compounds that exhibit an affinity to ionomeric materials. Nonlimiting examples of the latter include ionomeric precursors such as acid copolymers, homopolymers, monomers, and the like.

Where an adhesion promoting compound or material is incorporated into the material of the backing layer, it is contemplated that the incorporation may be homogeneous or nonhomogeneous depending on the nature and characteristics of the respective materials. Where a minor portion of an ionomeric material is blended with the major polymeric material employed in the backing layer 18, it is contemplated that the material may be processed such that the respective materials orient upon extrusion to provide a region proximate to one film surface that is richer in ionomeric material. Without being bound to any theory, it is believed that the ionomeric-rich surface region promotes bonding between the backing layer 18 and associated ionomer layer such as pigment layer 16.

The backing layer can have any thickness desired or required to promote bonding to the underlying substrate. Where employed, the backing layer may also contribute to overall film stability during and after extrusion processing. Nonlimiting examples of backing layer thickness include thicknesses up to 0.500 inch or greater. In certain applications thicknesses between 0.05 and 0.200 inch are employed. Backing layer thickness can vary depending on the specific end use application.

In the embodiment as depicted in FIG. 1, the polymeric film 12 may include a tie or adhesion layer 20. The adhesion layer 20 contains a melt processible thermoplastic polymer or polymer blend that exhibits an affinity to the overlying layer 16 and the backing layer 18 respectively. It is contemplated that the adhesion layer 20 contains a major portion of a suitable polyolefin. The adhesion or tie layer 20 material also contains a minor portion of a second thermoplastic material that exhibits an affinity to the overlying ionomeric layer. In a preferred embodiment of the invention as disclosed herein, the second thermoplastic material includes at least one of an ethylene-unsaturated carboxylic acid or anhydride, such as ethylene/acrylic acid copolymers, or ethylene-methacrylic acid copolymers, ionomers derived from sodium, lithium, or zinc, and ethylene/unsaturated carboxylic acid or anhydride such as ethylene-methacrylic acid copolymer. It is also contemplated that combinations of two or more of the foregoing can be employed as the second thermoplastic material. The concentration of the second thermoplastic material is in a range between about 20 and about 49 percent by weight based on the weight of the tie layer 20. In one embodiment, the concentration of the second thermoplastic polymer is between about 45 percent by weight based on the weight of the tie layer 20.

Nonlimiting examples of polyolefins that are used in the tie or adhesion layer 20 can include materials such as polyethylene, polypropylene, or polybutylene, as well as copolymers of ethylene, propylene, or butylenes with an alphaolefin. The alphaolefin can be selected from those alphaolefins containing from 3 to about 18 carbon atoms, including propylene, ethylene, butylenes, butene, hexane, 4-methylpentene, and octane. The polyolefin backing layer may be made by a blend of polyolefins such as polyethylene and ethylene propylene copolymers. Medium density polyethylene and the linear medium density polyethylenes are useful. A nonlimiting example of a useful polyolefin is a product available from A. Schulman identified as FI 134, which is believed to be an anhydride in an olefinic carrier.

As described above, the tie or adhesion layer 20 may include a second thermoplastic material selected from ethylene/unsaturated carboxylic acid or anhydride copolymers, ionomers derived from sodium, lithium, or zinc, and ethylene/unsaturated carboxylic acid or anhydride copolymers, as well as combinations of two or more thereof. Monomeric resin available from Exxon under the designation XV404 ionomeric precursor is a non-limiting example of suitable ionomeric materials.

As indicated, previously, it is also contemplated that other suitable adhesive resins can be incorporated into the backing layer and interposed as a distinct layer between the backing layer 18 and ionomeric layer 16. Nonlimiting examples of suitable adhesive resins can include materials such as ethylene/vinyl acetate copolymers. Suitable ethylene/vinyl acetate copolymers are available from Dupont under the trade designation “Elvax”. Examples include Elvax 3170 and 3190 LG. Adhesive resins available from Dupont under the trade name “Bynel” can also be used. These include ethylene/vinyl acetate resins available under trade designation Series 1100, acid-modified ethylene acrylic polymers (Series 2000), anhydride modified ethylene acrylic copolymers (Series 2100), anhydride-modified ethylene/vinylacetate copolymers (Series 3,000), acid-and-acrylate-modified ethylene/vinyl acetate resins (Series 3100), anhydride-modified ethylene/vinyl-acetate copolymers (series 3800), anhydride-modified ethylene/vinyl acetate resins (Series 3900), anhydride-modified high density polyethylene resins (Series 4,000), anhydride-modified linear low density polyethylene resins (Series 4100), anhydride-modified low density polyethylene resins (Series 4200), and anhydride-modified polypropylene resins (Series 5000). BYNEL CXA 1123 and BYNEL CXA 3101 are specific nonlimiting examples.

As indicated previously, it is contemplated that adhesive materials can be incorporated directly into the backing layer 18. When included in the backing layer, it is contemplated that the adhesive resin will be used at a concentration up to about 45%, or up to about 25 percent by weight. In one embodiment it is contemplated that the adhesive resin in the backing layer is an amount between about 1 percent and about 15 percent by weight. When used in the form of a distinct film layer between the backing layer and the ionomeric layer, it is contemplated that each of such adhesive resin films will have a thickness about 5 percent to about 25 percent of the thickness of the multilayer film 12, and in one embodiment a thickness between about 10 percent and about 20 percent. In a particular embodiment, for example, it is contemplated that the adhesive layer will have a thickness in a range between 0.001 and 0.05 inch with a range between 0.002 and 0.010 inch being contemplated and ranges between 0.002 and 0.004 inch being envisioned.

It is contemplated that colored articles 10 according to the embodiment(s) discussed herein include a suitable substrate 22 integrally attached to the backing layer 18. The substrate layer can be of any suitable thickness and configuration as dictated by the specifications and requirements of the finished article 10. The substrate 22 is composed of suitable injectable, melt-processible polymeric material(s). The material(s) of choice may exhibit thermoplastic or thermo setting characteristics. Nonlimiting examples of such materials are engineered polymers such as those characterized as thermoplastic elastomers (TPE). As used herein, the term “thermoplastic elastomer” refers to rubber-like materials that can be processed and recycled as thermoplastics. In particular, olefinic thermoplastic elastomers can be successfully employed. Such materials are commonly referred to as thermoplastic polyolefins (TPO). Olefinic thermoplastic elastomers can be materials having characteristics that allow the various components to soften and permit the polymeric matrix to flow at processing temperatures. When the material of choice cools, the hard segments solidify and re-establish a desirable rubber-like structure. Olefinic TPEs are typically multiphase material that includes crystalline or amorphous polyolefins such as polyethylene, polypropylene, and ethylene/propylene rubbers such as EPDM. Also included are materials such as polybutylene, polyisobutylene, polymethylpentene and the like. Materials of choice can have tensile strength in the range of 1,000 to 3,000 psi and melt temperatures in the range of 300° to 450° F.

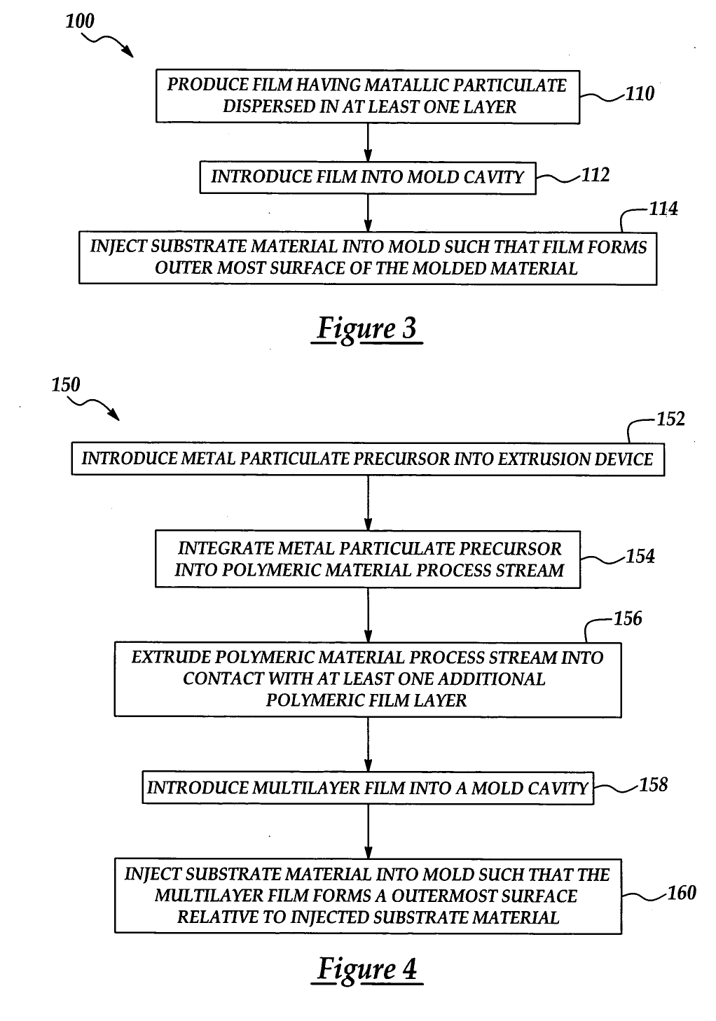

In order to produce an article 10 having a multilayer film 12, it is contemplated that the article 10 can be produced by the method disclosed herein as outlined in FIG. 3. The method 100 involves the step of producing a film having metallic particulate dispersed in at least one layer as at reference numeral 110. The film can be produced by any suitable method. As disclosed herein, it is contemplated that the film is produced by a suitable co-extrusion process utilizing processing temperatures, mixing speeds, and flow rates, that effectively produce a film having at least two layers such that the metallic particulate material is dispersed in at least one layer. It is contemplated that dispersion of the metallic particulate material is essentially uniform throughout the layer. As used herein, the term “essentially uniform” is taken to mean a dispersion of the metallic particulate material in a manner that exhibits minimal perceptible clumping or agglomeration of the metallic particulate. While the film layer containing metallic particulate dispersed therein may have any suitable melt processible thermoplastic material, it is contemplated that the polymeric materials will contain ionomeric polymers as outlined previously.

It is further contemplated that the metallic particulate material dispersed in the layer of the film will include various particles having different geometries. Thus, the material of choice is one that includes various particulate, spheroid, and other geometric configurations to provide optimal light refraction and aesthetic characteristics in the film and finished article. Generally, uniform dispersion will constitute agglomerations or concentrations of metallic particulate material at sizes less than 100 μm in depth and 50 μm in width and in occurrences less than 40 per square inch of produced film.

As broadly disclosed herein, the produced polymeric film will have at least one additional layer. It is contemplated that the layer in which the metallic particulate material is dispersed and the additional layer will have a polymeric matrix containing ionomeric compounds.

Metal particulate dispersion occurs in a manner that minimizes the introduction or incorporation of volatilizable compounds into the polymeric matrix. Without being bound to any theory, it is believed that incorporation of volatilizable materials occurs due to the presence of additive aids associated with the particulate material. Reduction of such additives with the concomitant addition of particulate material in a suitable ionomeric compatible matrix permits successful integration of pigment into the polymeric matrix of the pigmented layer 16. As disclosed herein additive concentration is maintained at or below a suitable volatilization threshold.

Volatilizable additives include, but are not limited to, water, waxes, encapsulation components, and the like. As defined herein, the term “volatilization threshold” is the additive concentration level above which significant volatilization phenomena is experienced upon subsequent extrusion processing. “Volatilization phenomena” are any process or event whereby at least a portion of the additive is converted to a gaseous material and/or reacts to form at least one gaseous compound or material capable of migrating through the polymeric matrix while in its molten or semi-molten state either during film formation or subsequent molding operations.

Occurrence of volatilization phenomena can be characterized by surface imperfections either at the layer/layer boundary or at the outer film surface of the resulting article. Such imperfections can adversely effect the aesthetic or visual appearance of the finished article.

It has also been found unexpectedly that integration of metallic particulate into a compatible concentrate that is then introduced into a process stream containing the polymeric matrix of polymeric layer 16 minimizes the occurrence and formation of gels and gel formation in the polymeric matrix material. As used herein, the germ “gel” is defined as localized regions of polymeric anomalies that mar the appearance and/or texture of the resulting film layer. Without being bound to any theory, it is believed that gels can be the result of a variety of reaction processes. Cross-link gels are the result of undesired crosslinking within the polymeric matrix and/or between the matrix and materials contained therein. The presence of cross-link gels manifests as regions of optical inconsistency and/or discoloration in the film matrix. Cross-link gels can vary in size from single micron regions to areas over 200+ microns in size and greater. Such gels are difficult to remediate and provide a focus for thermal discoloration and surface irregularity.

Entanglement gels have the appearance of cross-link gels but exhibit greater thermoplastic behavior in that portions of the gel region can be reduced or eliminated by appropriate thermal processing. Without being bound to any theory, it is believed that entanglement gels are the result of concentrated regions unreacted acid copolymer that can be converted with application of thermal and/or mechanical energy into the ionomeric polymer. Entanglement gels can vary in size to over 200+ microns in size.

Unmelt gel regions are the result of polymeric material that has been inadequately processed and has failed to enter the melted state in a uniform manner. Size is similar to that of cross-link and/or entanglement gels. The size and severity of unmelt gels can be addressed by application of heat.

It is currently hypothesized that at least a portion of undesired gel formation in the multilayer film 12 is due, at least in part, to interaction between metallic particulate material, and/or associated additives, and the ionomeric constituent in the polymeric matrix. This results in gels having a significant cross-linked characterization. Without being bound to any theory, it is believed that careful integration of particulate material contained in a carrier that is readily integratable into the polymeric material employed in layer 16 reduces the occurrence of cross-link gel formation and minimizes the tendency of metallic particulate to be the focus of gel formation.

The resulting polymeric film and various individual layers are characterized as having polymeric matrix in the film in which the polymeric matrix is an extruded thermoplastic exhibiting essentially unuiform polymerization throughout the matrix. As used herein, the term “essentially uniform polymerization” is defined as positioning of the thermoplastic polymeric material in the film layer without undue evidence of atypical polymeric cross-linking either spontaneous or metallic particulate focused. The polymeric matrix described and contemplated herein exhibits gel formation if at all in which the gels are less than 500 microns in size. Typically gel formation results in gel regions present in the polymeric layer that are widely distributed and have sizes less than 200 microns. Occurrences less than 40 per square inch in the produced film are contemplated.

The produced polymeric film is introduced into a suitable mold cavity as at reference numeral 112. The mold cavity is formed in a suitable injection mold die. The polymeric film is introduced such that the film is positioned proximate to at least a portion of the mold cavity surface. Introduction of the film can be accomplished can be by any means. Thus, the film can be coextruded and directly introduced into the mold cavity. Alternately, the produced film material can be accumulated, cut to size, etc., prior to positioning relative to the mold cavity surface.

Once the film is introduced into the mold cavity, a substrate material can be introduced into the mold cavity as at reference numeral 114 such that the film forms the outermost surface of the molded material upon completion of the mold cycle. It is contemplated that the injection molding process can be any suitable process for introducing a polymeric material such as a thermoplastic polyolefin (TPO) into the desired mold cavity to form the article of choice. The injection process occurs such that the introduced film forms an outermost surface of the resulting article formed of the molded material. Thus, location of injection port and selection of flow rates, injection pressures and the like will be adjusted to facilitate interposition of the film material between the cavity surface and the introduced injectable material.

It is contemplated that processing temperatures will be such that the film material is bonded to the substrate material in an essentially permanent fashion upon completion of the mold cycle. As used herein, the term “essentially permanent” is taken to mean that the substrate and overlying film material are integrally connected to one another throughout the life of the associated part.

In order to produce a molded article 10, a more detailed process such as that outlined in FIG. 4 can be employed. In order to produce the film layer 12 having at least one layer containing metal particulate material, the metal particulate can be contained in a suitable metal particulate concentrate that can be introduced into an appropriate extrusion device as at reference numeral 152. It is contemplated that the metal particulate concentrate is a concentrate containing metal particulate material in a suitable polymeric matrix associated with a suitable encapsulating agent as discussed previously. The material can be introduced into an appropriate extrusion device by any suitable means such as batch feeding, continuous process, or the like.

The metal particulate concentrate can be integrated into a suitable polymeric process stream as at reference numeral 154. Integration of the metal particulate precursor can be accomplished by any suitable method. As disclosed herein, one such method that is contemplated includes the pre-melting of the particulate concentrate and incorporation into the polymeric material process stream in a manner that preserves the geometric configuration of a significant portion of the metallic particulate material introduced therein. It is contemplated that a suitable blending screw or twin-screw blending device can be employed to integrate the material into the polymeric process stream.

The polymeric process stream can be composed of a suitable a melt processible polymeric material that contains a suitable ionomeric polymer. Where desired or required, the polymeric matrix of the metallic particulate precursor can be any suitable polymeric compound or composition capable of integration into the polymeric process stream. It is contemplated that various ionomeric materials may be employed. Where desired or required, a suitable colorant pigment material or materials can also be integrated into the polymeric material process stream. Integration of the pigment material can be accomplished by any suitable means desired or required.

Once any desired pigment and/or metallic materials have been integrated into the polymeric material process stream, the resulting material can be extruded into a film into contact with at least one additional polymeric film layer. It is contemplated that the polymeric material process stream and the additional polymeric film layer material can be coextruded to provide a multilayer film construct. The additional polymeric film layer can be composed of any material appropriate for the multilayer film construct. Examples of such materials include suitable ionomeric materials or other materials appropriate for a clear coat, additional polymeric material process stream layers containing suitable pigmentation or the like, suitable backing layers, and/or tie or adhesive layers. It is also contemplated that multiple layers can be coextruded to provide the final multilayer film construct.

The resulting multilayer film construct can be removed from the extrusion device and processed in any post-extrusion processes which may be desired or required. It is contemplated that the material can be stored in any suitable fashion, cut, and processed as desired or required, or subject to further treatment process as necessary or required.

In the process as disclosed herein, and outlined in FIG. 4, the resulting multilayer film is introduced into a suitable mold cavity as at reference numeral 158. The mold cavity can have any configuration or geometry suitable for producing the resulting end-use article. It is contemplated that the mold cavity can be one that is used with a suitable injection molding process and/or various injection/transfer processes. The multilayer film introduced into the mold cavity is positioned proximate to the surface of the cavity so as to be interposed between the mold cavity surface and material introduced into the mold cavity during the processing operation. Positioning can be by any suitable means. The multilayer film material can be held in position by any appropriate means including, but not limited to, electrostatic force and the like.

Once the film is in position in the mold cavity, a suitable substrate material can be introduced into the mold such that the film forms an outermost surface integral with substrate material as at reference numeral 160. Suitable substrate materials include, but are not limited to, suitable melt-processible elastomeric compounds such as TPOs.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law

1. A multilayer film comprising:
a clear coat layer comprising at least one extruded optically transmissive thermoplastic polymer; and
a visually reflective layer comprising at least one extruded thermoplastic material and at least one metallic particulate material interposed within the thermoplastic material, wherein the extruded thermoplastic is essentially uniform in polymerization.

2. The multilayer film of claim 1 wherein the extruded optically transmissive thermoplastic polymer and the extruded thermoplastic of the visually reflective layer are selected from the group consisting of ionomers and ionomeric precursors and wherein the metallic particulate material is at least one of metals or metalized compounds.

3. The multilayer film of claim 1 wherein the metallic particulate is associated with at least one carrier, the carrier material containing at least one extrudable thermoplastic material having a melting point between 100° C. and 250° C.

4. The multilayer film of claim 3 wherein the thermoplastic material of the carrier is selected from the group consisting of ionomers, ionomeric precursors, ionomer compatible polymers and mixtures thereof, and the carrier further contains at least one encapsulating agent, the translating agent being a hydrocarbon liquid having a thermal degradation temperature greater than 500° F.

5. The multilayer film of claim 1 further comprising a backing layer, the backing layer in layered relationship with the visually reflective layer at a location opposed to the clear coat layer.

6. The multilayer film of claim 1 wherein the metallic particulate material is present is at least one of aluminum, tin, or silver.

7. The multilayer film of claim 6 further comprising at least one tie layer interposed between the backing layer and the visually reflective layer, the tie layer containing at least one extrudable thermoplastic exhibiting an affinity to the visually reflective layer.

8. The multilayer film of claim 8 wherein the tie layer further contains an extrudable thermoplastic exhibiting an affinity to the backing layer.

9. The multilayer film of claim 7 wherein the backing layer further contains an extrudable thermoplastic exhibiting an affinity to the visually reflective layer.

10. A polymeric article comprising:
a molded substrate; and
at least one polymeric layer overlying at least a portion of the substrate, the polymeric layer having a metallic particulate material dispersed in an extruded thermoplastic material, the thermoplastic material characterized by essentially uniform polymerization.

11. The polymeric article of claim 10 wherein the polymeric layer contains at least one extrudable melt-processible thermoplastic selected from the group consisting of ionomers, ionomeric precursors, and mixtures thereof.

12. The polymeric article of claim 11 further comprising:
an optically transmissive layer in overlying relationship with the polymeric layer, the optically transmissive layer composed of an extrudable thermoplastic polymeric material.

13. The polymeric article of claim 12 further comprising a backing layer, the backing layer interposed between the polymeric layer and the substrate.

14. The polymeric article of claim 13 wherein the molded substrate contains a polymeric material selected from the group consisting of polyolefins, polycarbonates, polyamides, and mixtures thereof, and wherein the pigmented polymeric layer contains at least one extrudable melt-processible thermoplastic selected from the group consisting of ionomers, ionomeric precursors, and mixtures thereof.

15. The polymeric article of claim 14 wherein the backing layer is bonded to the molded substrate and wherein the backing layer contains a extrudable thermoplastic material selected from the group consisting of polyolefins, olefinic thermoplastic elastomers, and mixtures thereof.

16. The polymeric article of claim 15 wherein the polymeric film further compresses to the layer interposed between the backing layer and the polymeric layer, the polymeric layer containing at least one polymeric having adhesive affinity to the polymeric material in the polymeric layer.

17. A process for producing an article containing a pigmented polymeric film comprising the steps of:
introducing a polymeric film having a metallic particulate present in at least one layer into position in a mold cavity proximate to at least a portion of one surface of the mold cavity;
introducing a polymeric substrate material into the mold cavity such that the introduced substrate material contacts an inner face of the introduced polymeric film.

18. The process of claim 17 wherein the polymeric substrate is introduced into the mold cavity at a temperature sufficient to achieve bonding between the polymeric film and the introduced polymeric substrate.

19. The process of claim 18 wherein the polymeric film comprises at least one discrete layer having metallic particulate disposed therein, the at least one discrete layer containing a thermoplastic polymer selected from the group consisting of ionomers, ionomeric precursors, and mixtures thereof.

20. The process of claim 19 wherein the film further comprises at least one optically transmissive layer in overlying relationship with the polymeric layer interposed between the mold cavity surface and the polymeric layer, the optically transmissive layer containing a thermoplastic material selected from the group consisting of ionomers, ionomeric precursors, and mixtures thereof.

21. The process of claim 19 wherein the film further comprises a backing layer in linear relationship with the polymeric layer, the backing layer interposed between the polymeric layer and the introduced substrate material, the backing layer including at least one thermoplastic selected from the group consisting of polyolefins, and the polymeric substrate is composed of a polymeric material selected from the group consisting of polyolefins, polyamides, olefinic elastomers, and mixtures thereof.

22. The process of claim 19 wherein the polymeric film is extruded into the mold cavity.

23. The process of claim 19 wherein the polymeric film is extruded in a process comprising the steps of:
providing a polymeric process stream of melted thermoplastic containing metallic particulate material therein;
introducing the melted thermoplastic into a polymeric process stream to produce a polymeric layer;
co-extruding the pigmented polymeric layer with at least one additional layer.

24. A metallic particulate concentrate for integration into a polymeric process stream, the pigment concentrate comprising:
a polymeric carrier composed of a thermoplastic selected from the group consisting of ionomers, ionomeric precursors, ionomeric compatible materials, and mixtures thereof; and
metallic particulate material incorporated into the polymeric carrier, wherein the polymeric carrier is configured to facilitate integration into a polymeric matrix material.

25. The metallic particulate concentrate of claim 24 further comprising at least one compatibilizing additive, the compatibilizing additive present in a concentrate less than a volatilization threshold for the additive.

26. The metallic particulate concentrate of claim 24 wherein the metallic particulate is present in the carrier in a concentration up to 80% by weight of the polymeric carrier.

27. The metallic particulate concentrate of claim 24 wherein the metallic particulate is present in an amount between 5% by weight and 20% by weight.
